(19) United States
(12) Patent Application Publication
(10) Pub. No.: US 2025/0153452 A1
(43) Pub. Date: May 15, 2025

(54) Multi-Roller Calender for Producing Electrodes in a Dry Coating Method, Assembly for Laminating Both Sides of a Metal Foil with Electrode Paths, and Method for Producing an Electrode Path Using a Multi-Roller Calender

(71) Applicants: Matthews International Corporation, Pittsburgh, PA (US); Matthews International GmbH, Vreden (DE)

(72) Inventors: Uwe Paul STEINERT, Vreden (DE); Burkhard Karl WISSEN, Vreden (DE)

(21) Appl. No.: 18/838,000

(22) PCT Filed: Feb. 16, 2022
(86) PCT No.: PCT/DE2022/100129

§ 371 Date: Aug. 13, 2024

(51) Int. Cl. B30B 3/04; H01M 4/04

(52) U.S. Cl. CPC B30B 3/04; H01M 4/0435

(57) ABSTRACT

The invention relates to a multi-roller calender for producing electrodes in a dry coating method, comprising a plurality of rollers which are arranged one behind the other substantially in a main conveyor direction of an electrode path to be produced. A respective roller gap for passing through the electrode path is formed between each pair of adjacent rollers, which run in opposite directions, wherein at least two adjacent rollers of the plurality of rollers are arranged such that the outer radii thereof overlap in the main conveyor direction. The invention additionally relates to an assembly comprising two multi-roller calenders for laminating both sides of a metal foil with electrode paths and to a method for producing an electrode path using a multi-roller calender.

The invention relates to a multi-roller calender for producing electrodes in a dry coating method, with a plurality of rollers arranged one behind the other substantially in a main conveyor direction of an electrode path to be produced, wherein a respective roller gap for passing through the electrode path is formed between adjacent rollers rotating in opposite directions.

Electrodes can be used in electrical energy storage cells, which are widely used to power electronic, electromechanical, electrochemical and other useful devices. Such cells include batteries such as primary chemical cells and secondary (rechargeable) cells, fuel cells and various types of capacitors, including ultracapacitors. Electrodes can also be used in water treatment plants. Electromobility in particular is growing rapidly. The energy source in the electrically powered vehicle, the battery, accounts for a large proportion of the costs. This is directly related to their production. As a result, efficient and cost-effective production with an increase in energy density is required. The calendering process within the process chain for the production of lithium-ion battery cells is crucial in this regard.

The electrodes are key components for the storage potential of an energy storage. The electrochemical capabilities of electrodes, e.g. the capacity and efficiency of battery electrodes, are determined by various factors. These include the distribution of the active material, the binder and the additives, the physical properties of the materials contained therein, such as particle size and surface area of the active material, the surface properties of the active materials and the physical properties of the electrode film, such as density, porosity, cohesion and adhesion to a conductive element. In dry processing systems and methods traditionally a high shear and/or high pressure processing step is traditionally used to break up and mix the electrode film materials. Such systems and methods can contribute to structural advantages over wet-produced electrode films. However, high processing pressures and large machine dimensions (and thus large space requirements), which are needed to produce dry, self-supporting electrode films and dry electrodes, leave room for improvement.

US 2020/0 227 722 A1 discloses a multi-roller calender for producing a dry electrode for an energy storage device. The system comprises a first feed system for dry electrode material, multiple calender rollers arranged one behind the other and a control. The calender rollers are arranged in such a way that they each form a roller gap between them. A first roller gap is provided to receive the dry electrode material from the first feed system for dry electrode material and to form a dry electrode film from the dry electrode material.

The multi-roller calender known from the prior art has the disadvantage that in this the calender rollers are arranged linearly one behind the other in a main conveyor direction, so that due to the forces acting in the roller gaps, it may occur that one of the rollers forming the roller gap deviates laterally, resulting in inaccuracies in the thickness of the electrode path to be produced or vibrations in the system. The problem increases the larger the roller widths are selected. However, as demand for lithium-ion battery cells increases, it is necessary to use rollers with larger widths, among other things, in order to increase system productivity. There is therefore a need for solutions that prevent the above-mentioned problems.

It is therefore the object of the present invention to improve a multi-roller calendar in such a way that it enables greater process stability and is designed to produce a more uniform electrode path. The multi-roller calender according to the invention thus enables a simplified and more cost-effective method for the production of electrodes.

Accordingly, it is provided that at least two adjacent rollers of the plurality of rollers are arranged such that their outer radii overlap in the main conveyor direction. This ensures that as soon as the electrode path passes through the roller gap, the pressing forces required to guide it through the roller gap can be absorbed in a more targeted manner. This is achieved by overlapping the outer radii of the rollers in the main conveyor direction, as the rollers are thus not supported linearly against each other, but offset in relation to each other. As a result, the supporting roller can introduce a force component into the roller forming the roller gap, through which the electrode path presently passes, which counteracts the direction in which the roller forming the roller gap tends to deviate. The forces in the roller gap can increase in particular from the inlet to the outlet due to the increasing material compaction, so that the roller forming the roller gap tends to deviate accordingly, in particular against the conveyor direction of the electrode path. The main conveyor direction refers to the feed direction of the electrode path from one side to the other side of the multi-roller calender and substantially corresponds to the direction in which the individual rollers of the calender are arranged next to each other.

The multi-roller calender also has the advantage that an electrode path formed by the calender does not have to be self-supporting, as it can be positioned on a calender roller and supported by it during at least some, if not all, of the process steps. For example, the electrode path can be supported by at least one calender roller during all process steps within a multi-roller calender system, including the lamination step, if the electrode path is laminated onto a metal foil to form an electrode.

An energy storage device produced by using the multi-roller calender according to the invention may have any suitable configuration, such as planar, wound in a spiral, button-shaped, toothed or as a pouch. The energy storage may be a component of a system, e.g. a power generation system, an uninterruptible power source (UPS) system, a photovoltaic power generation system, an energy recovery system for use in, for example, industrial machinery and/or transport. The energy storage device can be used to power various electronic devices and/or motor vehicles, including hybrid electric vehicles (HEV), plug-in hybrid electric vehicles (PHEV) and/or electric vehicles (EV).

It may further be provided that the at least two adjacent overlapping rollers are arranged such that one of them is arranged perpendicularly offset to the other roller in relation to the main conveyor direction. In relation to a zero line, one of the rollers can have an offset of at least 1 mm, preferably 2 mm, particularly preferably 2.5 mm in relation to the zero line. In relation to the zero line, the other of the rollers can have an offset of at least 1 mm, preferably 2 mm, particularly preferably 2.5 mm in relation to the zero line. The first and second rollers can be offset in opposite directions relative to the zero line.

In addition, the at least two adjacent overlapping rollers can be arranged relative to each other in such a way that the center axis of the front roller is arranged in front of the roller gap relative to a direction transverse to the main conveyor direction and the center axis of the rear roller is arranged behind the roller gap relative to the direction transverse to the main conveyor direction, so that an electrode path guided through the roller gap is conveyed at least in portions counter to the main conveyor direction. For example, if the main conveyor direction is horizontal and the electrode path is conveyed substantially vertically downwards through a roller gap, the center axis of the front roller is located vertically above the roller gap and the center axis of the rear roller is located below the roller gap. If, conversely, the electrode path is conveyed substantially vertically upwards through a roller gap, the center axis of the front roller is located vertically below the roller gap and the center axis of the rear roller is located above the roller gap. The specified dimensions in front of and/or behind the roller gap can refer in particular to a feed direction of the electrode path through the respective roller gap. In other words, the front and rear rollers forming the roller gap can have opposite directions of rotation, which define the direction in which the electrode path passes through the roller gap, wherein, in relation to a direction substantially transverse to the main conveyor direction, the center axis of the front roller is arranged in front of the roller gap and the center axis of the rear roller is arranged behind the roller gap.

The rollers of the multi-roller calender can each be arranged relative to one another in such a way that the path of the electrode path between two adjacent roller gaps is respectively more than 180° of the circumference of the respective roller.

It may be provided that all rollers are offset from the zero line and that their outer radii overlap in relation to the main conveyor direction. It may be provided that all rollers are arranged such that their outer radii overlap in relation to the main conveyor direction and all adjacent rollers are arranged in relation to each other such that the center axis of the respective front roller is arranged in front of the roller gap in relation to a direction transverse to the main conveyor direction and the center axis of the respective rear roller is arranged behind the roller gap in relation to the direction transverse to the main conveyor direction. For example, the multi-roller calender can have a third roller which forms a second roller gap between itself and the second roller, which is arranged adjacent to and upstream of the third roller, wherein the second roller gap is designed such that it receives the electrode path guided around the second roller. The third roller can be arranged in such a way that its outer radius in relation to the main conveyor direction overlaps with the outer radius of the second roller, the second and third rollers being arranged relative to one another in such a way that the center axis of the second roller is arranged upstream of the second roller gap in relation to a direction transverse to the main conveyor direction and the center axis of the third roller is arranged downstream of the roller gap in relation to the direction transverse to the main conveyor direction. In a corresponding manner, the calender can have a fourth, fifth and sixth and/or seventh roller. It may be provided that the distances between the individual roller gaps can be individually controlled/adjusted. The multi-roller calender can also have one or more measuring devices, such as gamma measuring devices, for measuring the electrode path thickness or the specific mass for thickness control/measurement. For this purpose, a control can be provided which regulates the size of the roller gaps depending on the measured electrode path thickness. It may also be possible to control the temperatures of the individual rollers. For example, the temperature of the last roller of the multi-roller calender can be controlled in order to support the lamination of the dry electrode foil(s) onto the current collector or the metal foil.

It is conceivable that all gaps have the same gap height. Furthermore, it may be provided that the height of at least one rear roller gap in the main conveyor direction is smaller than at least one arranged in front of it. It may be provided that the roller gap height decreases progressively from the first to the last roller gap.

It may be provided that some of the roller gaps are arranged in a common pressing plane relative to one another. The multi-roller calender can have a plurality of rollers with the same diameter. These can be arranged in such a way that at least two gaps are formed between them, i.e. between rollers with the same diameter. These roller gaps of roller pairs with the same diameter can lie in a common plane in relation to the main conveyor direction.

The multi-roller calender can have an inlet side for feeding an electrode precursor material and an outlet side for discharging the electrode path formed from the electrode precursor material. The electrode precursor material can be fed perpendicular to the main conveyor direction.

It is conceivable that on the inlet side a roller gap for receiving the fed electrode precursor material is provided, which is formed by two rollers, which have a smaller diameter than two other rollers adjacent to them. By using rollers with a smaller diameter for feeding the electrode precursor material, in particular in powder form, the necessary high shear forces and/or a high pressure can be generated in the roller gap in order to break up and mix the electrode precursor material. The rollers with a smaller diameter can be offset in the same direction as the zero line. The front roller of the rollers can have an offset of at least 3 mm, preferably at least 4, particularly preferably 4.45 mm relative to the zero line. The other of the rollers can have an offset relative to the zero line of at least 8 mm, preferably at least 9 mm, particularly preferably 10 mm. The offset between the two rollers can thus be at least 3 mm, preferably 4 mm, particularly preferably at least 5 mm.

It can thus be provided that the rollers intended for receiving the electrode precursor material are the at least two adjacent overlapping rollers.

A roller arranged in front of the rollers provided for receiving the electrode precursor material in the main conveyor direction and adjacent thereto can be a support roller which does not form a roller gap with the first of the rollers with a smaller diameter, but is directly adjacent to it.

The support roller can be positioned in relation to the front roller of the rollers provided for receiving the electrode precursor material in such a way that the center axis of the support roller is arranged behind the roller contact region formed between them relative to a direction transverse to the main conveyor direction and the center axis of the front roller of the rollers provided for receiving the electrode precursor material is arranged in front of the roller contact region relative to the direction transverse to the main conveyor direction. In relation to the zero line, the support roller can be arranged opposite the roller arranged behind the second roller with a smaller diameter, i.e. the fourth roller in this combination. The support roller can have an offset of at least 1 mm, preferably 2 mm, particularly preferably 2.5 mm in relation to the zero line. The support roller can be offset from the fourth roller by at least 2 mm, preferably 4 mm, particularly preferably 5 mm.

It may be provided that the at least two adjacent overlapping rollers are driven at different rotational speeds. Each of the rollers can be controlled individually with regard to speed, acceleration, rotational speed, etc.

The rotational speed of the rear roller can be greater than the rotational speed of the first roller. If the multi-roller calender has multiple rollers, the rotational speed of the first roller can be the lowest, that of the second roller can be greater than that of the first roller, that of the third roller can be greater than that of the second roller and so on. These different speeds can ensure shearing within a film and/or generate forces that improve the adhesion of the film to the faster-running roller.

It is conceivable that the roller gap of the rollers provided for receiving the electrode precursor material is associated with a feeding device for feeding the electrode precursor material. The first roller gap can be designed in such a way that it receives the electrode precursor material from the feeding device and forms an electrode path from the electrode precursor material. The feeding device can be a funnel-shaped feed hopper. The hopper can be supplied with bulk material by means of suction or screw conveyors. The bulk material can be evenly distributed inside the feed hopper and the fill level can be kept constant during the feeding process. The formation of cavities and decomposition of the material can be prevented by a special mixer. A rotating dosing roller can be attached to the underside of the hopper. The size of the cells of the dosing roller can be selected according to the grain size of the bulk material. The bulk material can be picked up by the dosing roller and scraped off on a flexible squeegee. The precisely metered bulk material can then be conveyed to an oscillating brushing device. Following the brushing process, the bulk material can be inspected and transferred to the substrate line below.

The rollers can be fixed in a predetermined position with backlash-free bearings. Conical bearings or other bearing constructions can be used for the backlash-free fixing of rollers so that the low tolerances of the desired web thickness can be achieved. It is conceivable that the rollers have the same diameter for each roller gap or for the rollers within the roller gap. Alternatively, it is conceivable that the rollers have different diameters for each gap or for the rollers within the roller gap. The surfaces of the rollers can be coated to increase the surface hardness, e.g. with chrome or hard ceramic.

The invention also relates to an assembly comprising two multi-roller calenders according to any one of the preceding claims for laminating both sides of a metal foil with electrode paths, which are arranged in such a way that the electrode paths formed therein are conveyed in opposite main conveyor directions, wherein the downstream end rollers of both multi-roller calenders form an end roller gap and rotate in opposite directions, so that a metal foil fed to the end roller gap is coated on both sides with the respective electrode paths guided into the end roller gap.

It may be provided that the downstream end rollers are not offset from each other, so that the laminated foil is guided through the end roller gap substantially perpendicular to the main conveyor direction of the electrode paths.

The assembly may further comprise a feeding device arranged between the first and the second multiple roller calender, which is configured to continuously feed a metal foil into the end gap. The end gap can be designed in such a way that it receives the metal foil and laminates one electrode path on one side and the other electrode path on the other side of the metal foil. One electrode path can be a cathode path and the other electrode path an anode path. The rollers forming the end gap can have one or more gap control actuators. The one or more gap control actuators may be configured to generate and control opposing forces between the first and second rollers forming the end gap during lamination. It may be provided that the metal foil is pre-coated with adhesive before being fed into the end gap, or the adhesive can be applied to one side of the foil via a separate powder hopper on the multi-roller calender, so that direct lamination to the foil is possible without prior pre-coating of the material. After the laminating step, the assembly can have a cutting device to cut the laminated web to the final electrode width and wind up the individual electrode reels.

The invention further relates to a method for producing an electrode path with a multi-roller calender according to any one of claims 1 to 15 or an assembly according to any one of claims 16 to 17, comprising the steps of:
feeding an electrode precursor material into an inlet-side roller gap of the multi-roller calender formed by an upstream roller and a downstream roller;
passing the electrode precursor material through the inlet-side gap, thereby forming an electrode path;
guiding the electrode path around the downstream roller;
passing the electrode path through at least one further roller gap;
removing the electrode path from the multi-roller calender;
wherein while the electrode precursor material and/or the electrode path are passed through the at least one roller gap, the conveyor direction of the electrode path has a component of movement opposite to a main conveyor direction of the electrode path.

It may be provided that in the method the electrode path is guided around the downstream roller by more than 180°.

In particular, it may be provided that the rotational speed of the downstream roller is greater than the rotational speed of the upstream roller.

It may be provided that the discharge of the electrode path from the multi-roller calender comprises laminating the electrode path onto a metal foil.

It may be provided that the method comprises the production of two electrode paths which are conveyed in opposite main conveyor directions, wherein when the electrode paths are discharged from the respective multi-roller calenders, the electrode paths are laminated on both sides onto a metal foil.

The method can be preceded by a process for preparing the electrode precursor material, which can be a powder. This process can start with the dry mixing of dry active material particles, dry conductive particles and dry binder particles to form a first dry mixture. In addition, dry conductive particles and dry binder particles may also be dry mixed to form a second dry mixture that can be fed to a dry fibrillation step. In the dry fibrillation step, the dry mixture can be fibrillated using a jet mill. During the dry fibrillation step, high shear forces are exerted on the dry mixture to physically stretch it and form a network of thin web-like fibers. In a drying feed step, the separately formed first and second dry mixtures can be fed into corresponding containers to form a dry film. The dry film can then be fed to the multi-roller calender and compacted and calendered therein to obtain an embedded/intermixed electrode path or a self-supporting electrode path. The electrode path is then attached to a current collector (e.g. a metal foil).

The advantage of this method is that a self-supporting electrode path produced in this way can have improved properties with respect to one produced in a wet process. For example, a dry electrode path may have one or more of the following properties: improved web strength, improved cohesion, improved adhesion, improved electrical performance, or reduced occurrence of defects. Defects may include holes, cracks, surface depressions in the electrode path. The adhesion can be the adhesion to a current collector. The electrical performance can relate to the specific capacity. The web strength can be the tensile strength.

Further details of the invention are explained with reference to the figures below. In particular:

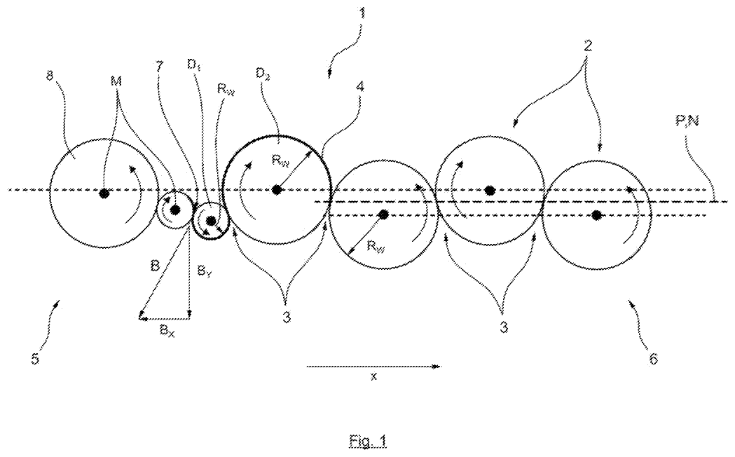

FIG. 1 shows a schematic side view of a roller assembly of the multi-roller calender according to the invention;

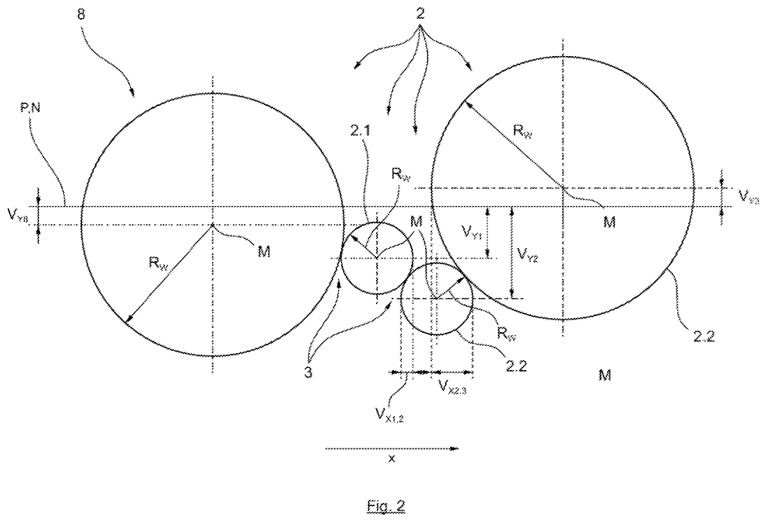

FIG. 2 shows a schematic side view of an inlet-side roller combination of the multi-roller calender according to the invention;

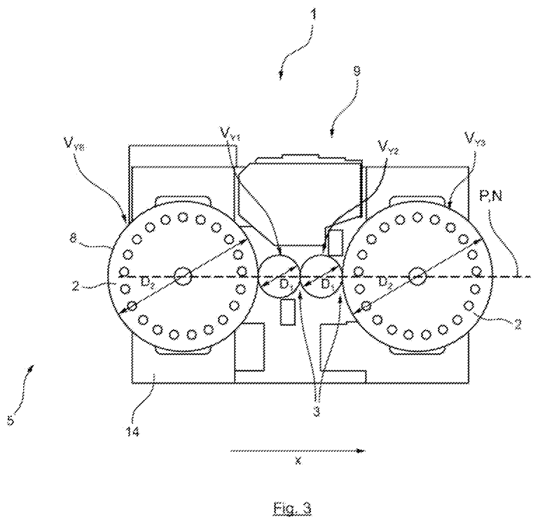

FIG. 3 shows a side view of an embodiment of an inlet-side roller combination of the multi-roller calender according to the invention;

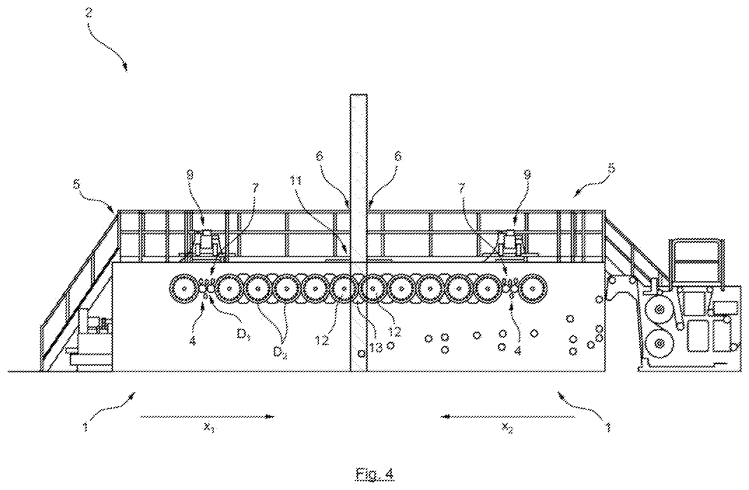

FIG. 4 shows a side view of an embodiment of an assembly consisting of two counter-rotating multi-roller calenders.

FIG. 1 shows a side view of an exemplary embodiment of the roller assembly of the multi-roller calender 1 according to the invention. The assembly shown has a total of 7 rollers 2 positioned next to each other in a main conveyor direction X, which are each offset relative to each other and offset relative to a zero line N or a pressing plane P. The rollers 2 are offset from one another in a vertical direction on the one hand and offset from one another in the main conveyor direction X on the other, so that the outer radii R_{w} of the rollers 2 respectively overlap in the main conveyor direction X. The left half of the figure shows the inlet side 5 of the multi-roller calender 1. In it, an electrode precursor material 7 is fed from above via a feeding device 9, not shown, to the roller gap of the second and third rollers from the left, which have a smaller diameter D₁ than the other rollers 2, which have a larger diameter D₂, and is fed through the two rollers 2 with the diameter D₁ under a

[symbol]

[symbol]

predetermined roller gap pressure. On the opposite side of the roller gap 3, the electrode path 4 generated by the pressure is guided around the underside of the third roller 2 and fed to the second roller gap 3 between the third and fourth rollers 2 shown in the figure, wherein the third roller has the diameter D1 and the fourth roller has the diameter D2. The electrode path 4 respectively adheres to the following roller 2 in that the downstream rollers 2 each have a higher rotational speed than the upstream rollers 2 adjacent to them. The higher speed of the downstream roller 2 causes shearing of the electrode path 4 in the roller gap 3, so that the electrode path 4 adheres to the roller 2 at a higher speed. The first roller 8 on the left in the illustration has no function in terms of conveying the electrode path 4. Instead, it serves to support the second roller 2 or the first roller with a smaller diameter D₁. Therefore, there is no roller gap 3 provided between these two rollers, but the rollers 2 are in direct contact with each other. As shown, adjacent rollers 2 rotate in opposite directions. In the example shown, the support roller 8 rotates counterclockwise, the second clockwise, the third again counterclockwise and so on. The rollers 2, between which the electrode path 4 is passed in a zigzag pattern, are each arranged relative to one another in such a way that the center axis M of the front one of the rollers 2 forming a roller gap 3 is arranged in front of the roller gap 3 relative to the vertical and the center axis M of the rear one of rollers 2 is arranged behind the roller gap 3. For example, the second roller 2 rotates clockwise and the third counterclockwise, so that the feed direction of the electrode path 4 through the roller gap 3 formed by the second and third roller 2 runs substantially vertically downwards. The center axis M of the second roller 2 is now arranged above the roller gap 3 and the center axis M of the third roller 2 is arranged below the roller gap 3. In the adjacent gap 3 between the third and fourth roller 2, the feed direction points substantially vertically upwards, so that accordingly the center axis M of the third roller 2 is below the roller gap 3 and the center axis M of the fourth roller 2 lies above the roller gap 3. This arrangement of the rollers 2 results in the direction of movement B of the electrode path 4 respectively having a vertical component B_{Y} and a horizontal component B_{X}, wherein the horizontal component B_{X} is respectively orientated against the main conveyor direction X. The roller assembly shown also has the property that the path travelled by the electrode path 4 in each case on a roller surface is greater than 180° of the circular arc of the respective roller. The electrode path is led out of the multi-roller calender 1 at an outlet side 6.

FIG. 2 shows once again in detail the first four rollers 2 arranged on the inlet side, the center rollers 2 of which form the roller gap 3 for receiving the supplied electrode precursor material 7. The offset between the individual rollers 2 is shown greatly enlarged in relation to the roller diameters for clarity of representation. In relation to a zero line N, the first roller or the support roller 8 has an offset V_{Y8}, which lies vertically below the zero line N. In relation to the zero line N, the second roller 2 has an offset V_{Y1} which is also vertically below the zero line N and is greater than the offset V_{Y8} of the first roller 8. In relation to the zero line N, the third roller 2 has an offset V_{Y2}, which is also vertically below the zero line N and is greater than the offset V_{Y1} of the second roller 2. In relation to the zero line N, the third roller 2 has an offset V_{Y3} which is vertically above the zero line N and corresponds to the offset V_{Y8} of the first roller 8. In the example shown, the offset V_{Y8} is 2.5 mm, the offset V_{Y1} is 4.45 mm, the offset V_{Y2} is 10 mm and the offset V_{Y3} is 2.5 mm. In the horizontal direction, i.e. along the main conveyor direction X, the second roller has an overlap V_{X1,2} with the third roller, and the third roller has an overlap V_{X2,3} to the fourth roller, which is greater than the overlap V_{X1,2}. In relation to the roller gap 3 between the second and third roller, the second roller 2 represents the front roller 2.1 and the third roller 2 is the rear roller 2.2. In relation to the roller gap 3 between the third and fourth roller, the third roller 2 represents the front roller 2.1 and the fourth roller 2 the rear roller 2.2.

FIG. 3 shows the first four rollers 2 arranged on the inlet side in the installed state and with actual dimensions. In particular, the feeding device 9, by means of which the powdery electrode precursor material 7 is fed into the roller gap 3 between the second and third roller 2, can be recognized in the figure. The feeding device 9 is arranged vertically above the roller gap 3, so that the electrode precursor material 7 is conveyed into the roller gap 3 with the aid of gravitational force. The rollers are each mounted independently of one another in a calender frame 14 and can be controlled independently of one another, in particular with regard to the gap adjustment and the respective rotational speed of the rollers 2.

FIG. 4 shows an assembly 2 for producing a metal foil coated on both sides with electrodes. The assembly 2 has two multi-roller calenders 1 positioned end to end, which have opposing main conveyor directions X1, X2. The multi-roller calenders each have eight rollers 2, wherein the end roller on the inlet side is designed as a support roller 8 and the end rollers on the outlet side form a common end roller gap 13. A metal foil 11 is fed vertically from above to the end roller gap 13, which foil is coated on both sides by means of the electrode paths 4 produced in the two multi-roller calenders 1, so that the coated metal foil 11 leaves the end roller gap 13 vertically downwards and can then be cut to length and/or rolled up or further processed.

The features of the invention disclosed in the above description, in the drawings and in the claims can be essential for the implementation of the invention both individually and in any combination.

### LIST OF REFERENCE NUMERALS

1 multi-roller calender
2 rollers
2.1, 2.2 overlapping rollers
3 roller gap
4 electrode path
5 inlet side
6 outlet side
7 electrode precursor material
8 support roller
9 feeding device
10 assembly
11 metal foil
12 end rollers
13 end roller gap
14 calender frame
B direction of movement in the roller gap
B_{X} component of movement against the main conveyor direction
B_{Y} component of movement perpendicular to the main conveyor direction
D₁ small diameter
D₂ large diameter
M center axes of the rollers
N zero line
P pressing plane
R_{W} outer radii
V_{Y8} offset of support roller perpendicular to the main conveyor direction
V_{Y1} offset of first roller perpendicular to the main conveyor direction
V_{Y2} offset of second roller perpendicular to the main conveyor direction
V_{Y3} offset of third roller perpendicular to the main conveyor direction
V_{X1,2} offset of first and second roller in main conveyor direction
V_{X2,3} offset of second and third roller in main conveyor direction
X main conveyor direction

1. A multi-roller calender for producing electrodes in a dry coating method,
comprising a plurality of rollers arranged one behind the other substantially in a main conveyor direction of an electrode path to be produced, wherein between adjacent and respectively counter-rotating rollers a respective roller gap for passing through the electrode path is respectively formed between adjacent rollers, which respectively rotate in opposite directions,
characterized in that at least two adjacent rollers of the plurality of rollers are arranged such that their outer radii (R_{W}) overlap in relation to the main conveyor direction (X).

2. The multi-roller calender according to claim 1, wherein the at least two adjacent overlapping rollers are arranged in such a way that one of them is arranged perpendicularly offset to the other roller with respect to the main conveyor direction (X).

3. The multi-roller calender according to claim 1, wherein the at least two adjacent overlapping rollers are arranged relative to one another in such a way that the center axis (M) of the front roller is arranged in front of the roller gap relative to a direction transverse to the main conveyor direction (X) and the center axis (M) of the rear roller is arranged behind the roller gap with respect to the direction transverse to the main conveyor direction (X), so that an electrode path guided through the roller gap is conveyed at least in portions against the main conveyor direction (X).

4. The multi-roller calender according to claim 1, wherein the path of the electrode path between two adjacent roller gaps is respectively more than 180° of the circumference of the respective roller.

5. The multi-roller calender according to claim 4, wherein all rollers are arranged such that their outer radii (R_{W}) overlap with respect to the main conveyor direction (X) and all adjacent rollers are arranged with respect to each other such that the center axis (M) of the respective front roller is in front of the roller gap in relation to a direction transverse to the main conveyor direction (X) and the center axis (M) of the respective rear roller is arranged behind the roller gap in relation to the direction transverse to the main conveyor direction (X).

6. The multi-roller calender according to claim 1, wherein all gaps have the same gap height.

7. The multi-roller calender according to claim 1, wherein the height of at least one rear gap in the main conveyor direction (X) is less than that of at least one gap arranged in front of it.

8. The multi-roller calender according to any one of the preceding claims, wherein at least some of the roller gaps are arranged relative to one another in a common pressing plane (P).

9. The multi-roller calender according to claim 1, wherein the multi-roller calender has an inlet side for feeding an electrode precursor material and wherein the multi-roller calender has an outlet side for discharging the electrode path formed from the electrode precursor material.

10. The multi-roller calender according to claim 9, wherein an inlet-side roller gap for receiving the supplied electrode precursor material is provided, which is formed from two rollers which have a smaller diameter (D₁) than two further rollers respectively adjacent thereto.

11. The multi-roller calender according to claim 10, wherein the rollers provided for receiving the electrode precursor material are the at least two adjacent overlapping rollers.

12. The multi-roller calender according to claim 10, wherein the roller arranged in front of the rollers provided for receiving the electrode precursor material in the main conveyor direction (x) and adjacent thereto is a support roller, which does not form a roller gap with the first of the rollers with a smaller diameter (D1), but is directly adjacent thereto.

13. The multi-roller calender according to claim 12, wherein the support roller is arranged in relation to the front roller of the rollers provided for receiving the electrode precursor material in such a way that the center axis (M) of the support roller is arranged behind the roller contact region formed between them with respect to a direction transverse to the main conveyor direction (X) and the center axis (M) of the front roller of the rollers provided for receiving the electrode precursor material is arranged in front of the roller contact region in relation to the direction transverse to the main conveyor direction (X).

14. The multi-roller calender according to claim 1, wherein the at least two adjacent overlapping rollers are driven at different rotational speeds.

15. The multi-roller calender according to claim 10, wherein a feeding device for feeding the electrode precursor material is associated with the roller gap of the rollers provided for receiving the electrode precursor material.

16. An assembly comprising two multi-roller calenders according to claim 1 for laminating both sides of a metal foil with electrode paths, which are arranged in such a way that the electrode paths formed therein are respectively fed in opposite main conveyor directions (X), wherein the downstream end rollers of both multi-roller calenders form an end roller gap and rotate in opposite directions, so that a metal foil fed to the end roller gap is coated on both sides with the electrode paths respectively guided into the end roller gap.

17. The assembly according to claim 16, wherein the downstream end rollers have no offset relative to one another, so that the laminated metal foil is guided through the end roller gap substantially perpendicular to the main conveyor direction (X) of the electrode paths.

18. A method for producing an electrode path using a multi-roller calender according to claim 1, comprising the steps of:
feeding an electrode precursor material into an inlet-side roller gap of the multi-roller calender formed by an upstream and a downstream roller;
passing the electrode precursor material through the inlet-side roller gap and thereby forming an electrode path;
guiding the electrode path around the downstream roller;
passing the electrode path through at least one further roller gap;
discharging the electrode path from the multi-roller calender;
wherein, when passing the electrode precursor material and/or the electrode path through the at least one roller gap, the conveyor direction of the electrode path has a component of movement opposite to a main conveyor direction (X) of the electrode path.

19. The method according to claim 18, wherein the electrode path is guided by more than 180° around the downstream roller.

20. The method according to claim 18, wherein the rotational speed of the downstream roller is greater than the rotational speed of the upstream roller.
